(19) United States
(12) Patent Application Publication
(10) Pub. No.: US 2013/0132231 A1
(43) Pub. Date: May 23, 2013

(54) Remote Ordering Apparatus and Method

(71) Applicant: Stephen Teudt, Fairlight (AU)

(72) Inventor: Stephen Teudt, Fairlight (AU)

(73) Assignee: MASTEDA LABS Pty Ltd, Frenchs Forest, NSW (AU)

(21) Appl. No.: 13/813,124

(22) PCT Filed: Aug. 5, 2011
(86) PCT No.: PCT/AU2011/000990

§ 371 Date: Jan. 29, 2013

(30) Foreign Application Priority Data
Aug. 6, 2010 (AU) 2010903513

(51) Int. Cl. G06Q 30/06

(52) U.S. Cl. CPC G06Q 30/0633
USPC 705/26.8

(57) ABSTRACT

A remote ordering apparatus and method. The apparatus being coupled to a digital data network to enable communication to a client device for presenting a client interface. The ordering apparatus comprising: a database comprising merchant data; a web server device coupled to the data network and adapted to interrogate the database. The web server device comprises a server module for providing a client interface configured to receive a client order; the server device further comprises a print service module; the print service module being operatively associated with the server module for enabling communication of an order print request data to a remote printer device over a data network.

### FIELD OF THE INVENTION

The present invention relates to ordering apparatus and methods, and in particular to apparatus and methods for remote ordering of goods or services.

The invention has been developed primarily for use as a remote ordering apparatus and method for take-away goods and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known devices for remote ordering are disclosed in PCT application publications WO 2006/133713 and WO 2010/037394. These publication discloses an apparatus requiring a remote device to transmit an acknowledgement that a client order was received, and/or confirmation of an estimated pickup time.

There is a need in the art for an apparatus that enables a client to select a suitable pickup time, and/or monitor availability of remote order delivery.

### OBJECT OF THE INVENTION

It is an object of the present invention to overcome or ameliorate at least one of the disadvantages of the prior art, or to provide a useful alternative.

It is an object of the invention in its preferred form to provide an apparatus for remote ordering.

### SUMMARY OF THE INVENTION

According to an aspect of the invention there is provided a remote ordering apparatus, the apparatus being coupled to a digital data network to enable communication to a client device for presenting a client interface, the ordering apparatus comprising:
a database comprising merchant data;
a web server device coupled to the data network and adapted to interrogate the database;
wherein the web server device comprises a server module for providing a client interface configured to receive a client order; the server device further comprises a print service module; the print service module being operatively associated with the server module for enabling communication of an order print request data to a remote printer device over a wireless data network.

According to an aspect of the invention there is provided a processor apparatus for remote ordering, the apparatus being coupled to a digital data network to enabling communication to a client device for presenting a client interface, the ordering apparatus comprising:
a database comprising merchant data;
a web server device coupled to the data network and adapted to interrogate the database;
wherein the web server device comprises a server module for providing a client interface configured to receive a client order; the server device further comprises a print service module; the print service module being operatively associated with the server module for enabling communication of an order print request data to a remote printer device over a wireless data network.

Preferably, the client interface enables a client to be authenticated, select a merchant, place an order. More preferably, the client interface enables a client to select a pickup time for the order. Most preferably, the client interface presents a minimum delay for the order to be available based on merchant data and time of day. The client interface preferably enables a client to make a payment for the order.

Preferably, the web server device is coupled to a financial server device for processing payment of a client order. More preferably, a refund can be provided. Most preferably, print request data includes a cancelation identifier for enabling a client to obtain a refund.

Preferably, the remote printer device prints an order request. More preferably, the order request includes a cancelation reference identifier. Most preferably, the client can input the cancelation reference identifier to the client interface to obtain a refund.

Preferably, the database includes client data indicative of a client. Client data can preferably comprise any one or more of: contact details, past orders, status of current orders, and payment detail.

Preferably, the merchant data is indicative of a merchant services or goods. More preferably, merchant data can include any one or more of the following: contact details, payment details, goods or services data. Most preferably, merchant services data can further include any one or more of the following: menu details, and time of day order delay details, operating hours, and holiday schedule. Merchant data preferably includes operating hours and minimum delay time for proceeding an order with respect to time of day and/or number and type of items.

Preferably, the print service module monitors availability of the remote printer. More preferably, a watchdog timer module is used in monitoring availability of the remote printer. The watchdog timer module is preferably reset by receiving a response to a print request from the remote printer. Alternatively, the watchdog timer module is preferably reset by receiving a response to a handshake request. A handshake request-response can include issuing a PING request and receiving a valid response.

Preferably, the print server module establishes a communication link to the remote printer over a wired network. The communication link can preferably be established over a combination of a wired data network and wireless data network. Alternatively, the communication link can be over a direct proprietary wireless data network. The communication link preferably includes a synchronous 3G data network.

Preferably, a third-party server device coupled to the digital data network can be operatively associated with the print service module for communicating order print request data to a remote printer device. The third-party server device is preferably registered, and authenticated. The database preferably comprises data indicative of the third-party device registration and/or authentication.

According to an aspect of the invention there is provided a client access interface for a processor device, the processor device being adapted to enable remote ordering, the processor device being coupleable to database having merchant data; the interface comprising: a control program adapted to:
receive data indicative of a client order;
prepare print request data;
communicate print request data to a remote printer.

According to an aspect of the invention there is provided a method of remote ordering in a computer apparatus, said method comprising the steps of:
receiving data indicative of a client order;
preparing print request data;
communicating print request data to a remote printer.

According to a further aspect of the invention there is provided a computer program product stored on a computer usable medium, the computer program product adapted to provide a method of remote ordering as herein described.

According to a further aspect of the invention there is provided a computer readable medium for operation with a processor device to enable remote ordering, the computer readable medium comprising computer code for executing a method as herein described.

According to a further aspect of the invention there is provided a computer program product stored on a computer usable medium, the computer program product adapted to provide an access interface for a computer device, the computer device being coupleable to database having one or more records indicative of merchant data; the computer program product comprising:
computer readable program means for executing one or more steps of a method as herein described.

Preferably, the method further comprises the step of authenticating a client. More preferably, the method further comprises the step of processing payment of the order. Most preferably, the method further comprises the step of establishing an estimated order availability time. The earliest estimated order availability time is presented in a client interface using a calculated minimum delay based on merchant data and time of day.

Preferably, remote ordering includes remote ordering of goods from a merchant. More preferably, goods ordered from a merchant are prepared upon receiving the client order. Most preferably, goods ordered from a merchant include take-away comestibles. Alternatively, remote ordering includes remote ordering of services from a merchant.

### BRIEF DESCRIPTION OF THE DRAWINGS

A preferred embodiment of the invention will now be described, by way of example only, with reference to the accompanying drawings in which:

FIG. 1A is a schematic view of an embodiment remote ordering apparatus according to the invention;

FIG. 1B is a schematic view of an embodiment remote ordering apparatus according to the invention;

FIG. 1C is a schematic view of an embodiment remote ordering apparatus according to the invention;

FIG. 1D is a schematic view of an embodiment remote ordering apparatus according to the invention;

FIG. 2 is a data flow diagram of an embodiment remote ordering apparatus according to the invention;

FIG. 3 is a flowchart of an embodiment remote ordering method according to the invention;

FIG. 4 is a flowchart of an embodiment remote ordering method according to the invention;

FIG. 5A is a tabular view of merchant data used in an embodiment remote ordering apparatus according to the invention, representing menus data for a cafe;

FIG. 5B is a tabular view of merchant data used in an embodiment remote ordering apparatus according to the invention, representing menus data for a cafe;

FIG. 5C is a tabular view of merchant data used in an embodiment remote ordering apparatus according to the invention, representing menus data for a cafe;

FIG. 5D is a tabular view of merchant data used in an embodiment remote ordering apparatus according to the invention, representing menus data for a cafe;

FIG. 5E is a tabular view of merchant data used in an embodiment remote ordering apparatus according to the invention, representing menus data for a cafe;

FIG. 5F is a tabular view of merchant data used in an embodiment remote ordering apparatus according to the invention, representing menus data for a cafe;

FIG. 6 is a tabular view of merchant data used in embodiment remote ordering apparatus according to the invention, representing delay data;

FIG. 7 is a file content view of an embodiment print template for remote ordering apparatus according to the invention;

FIG. 8 is a schematic view of an embodiment remote ordering apparatus according to the invention;

FIG. 9 is a schematic view of the print service module of FIG. 8;

FIG. 10 is a state diagram of the print service module of FIG. 8;

FIG. 11 is a state diagram of the remote printer interface of FIG. 8;

FIG. 12A is an example of a printed order request; and

FIG. 12B is an example of a printed order request.

### PREFERRED EMBODIMENT OF THE INVENTION

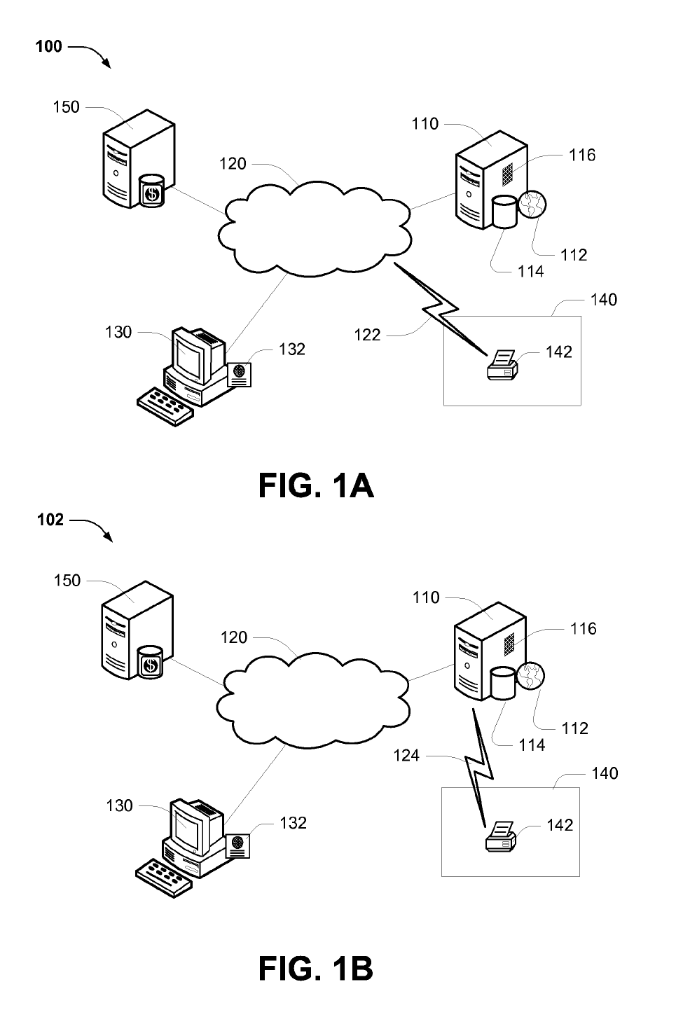

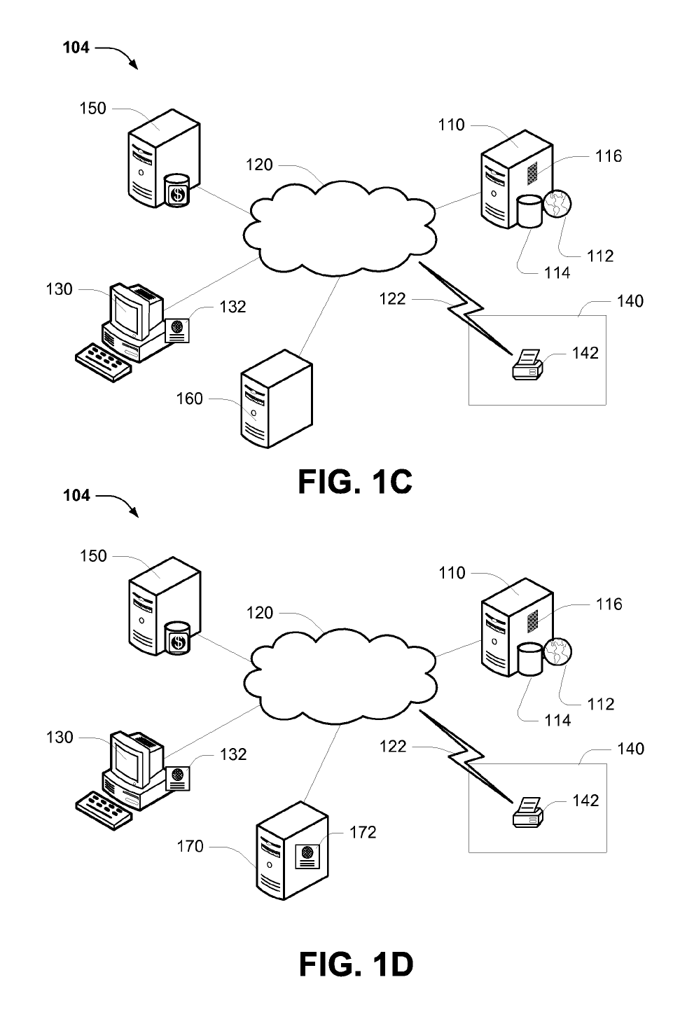

Referring initially to FIG. 1A, FIG. 1B and FIG. 1C of the drawings, example schematic views of an embodiment remote ordering apparatus is disclosed.

FIG. 1A shows a remote ordering apparatus 100 comprising a web server device 110 coupled to a digital data network 120. The web server device 110 includes a web server module 112 adapted to communicate with a client device 130 for presenting a client interface 132. The web server device 110 is further coupled to a database 114 comprising merchant data, and is adapted to interrogate the database.

In this example embodiment, the web server device 110 comprises a server module 112 for providing a client interface configured to receive a client order. The server device further comprises a print service module 116. The print service module being operatively associated with the server module for enabling communication of an order print request data to a merchant 140 over a wireless data network 122 for printing by remote printer device 142. The server module 112, upon receiving a client order, generate an associated order print request data. The print service module 116 is adapted to receive order print request data and to manage printing by the remote printer.

A client interface 132 is generated by the server module 112 and can be presented (or rendered) at the client device 130.

Referring to FIG. 1B, communication between the web server device 110 and the remote printer device 140 can be provided over a dedicated wireless link 124.

Referring to FIG. 1C, a third-party server device 160 is coupled to the digital data network 120 to be operatively associated with the print service module 116 for communicating order print request data to a remote printer device 142. The third-party server device is preferably registered, and authenticated. The database preferably comprises data indicative of the third-party device registration and/or authentication.

Referring to FIG. 1D, merchant data stored in the database 114 can be updated by an authenticate merchant device 170 via a merchant interface 172. Once authenticated, The merchant can modify, remove or replace merchant data stored in the database. It will be appreciated that this merchant data is used when presenting a client interface.

The merchant interface and client interface are HyperText Markup Language (HTML) based web interfaces. Typically, Cascading Style Sheets (CSS), Extensible Markup Language (XML), Asynchronous JavaScript and XML (AJAX), JavaScript Object Notation (JSON) and/or Dynamic HyperText Markup Language (DHTML) technologies are used in presenting or rendering the interface. This enables a merchant to provide goods and/or service details in a standardised form which can be directly (or indirectly) rendered within a client interface.

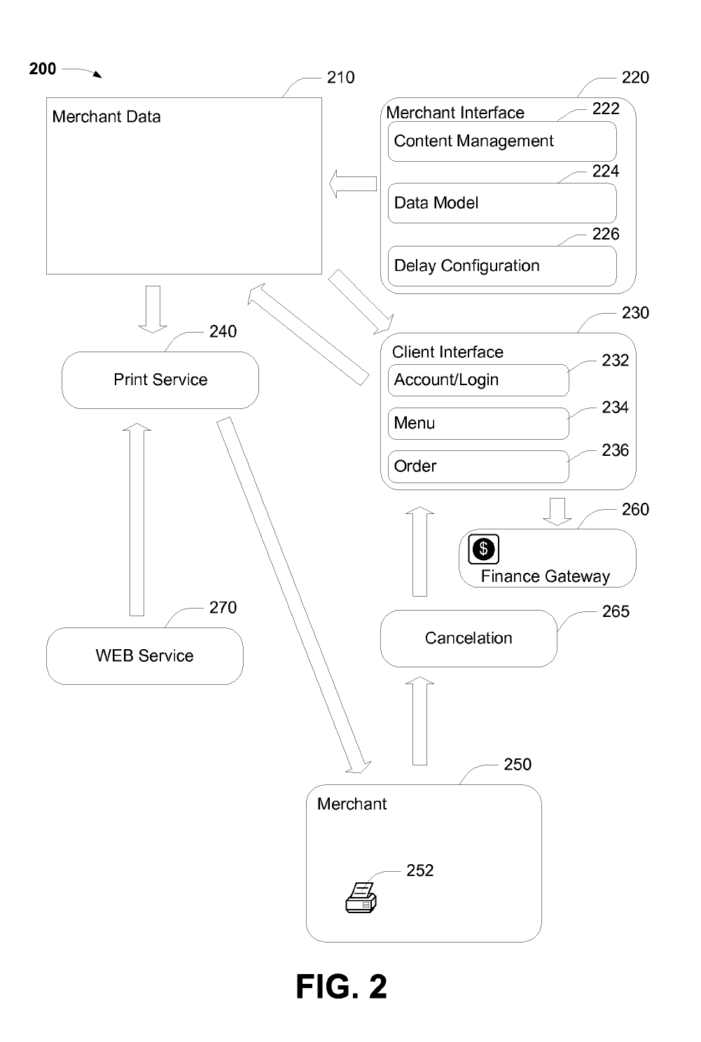

FIG. 2, shows a data flow diagram 200 of an embodiment remote ordering apparatus.

In this embodiment, merchant data 210 stored in the database (as shown in FIG. 1A though FIG. 1D by 114) can be modified, removed or replaced vi a merchant interface 220. A merchant can, via the merchant interface, manage merchant data content 222, upload or amend merchant data indicative of a goods or services data model 224, and/or specify specific delay configurations 226.

The merchant data indicative of a goods or services can be provided in a standardised data model format as specified below. This merchant data can be rendered when presenting a HTML client interface.

The merchant data indicative of specific delay configurations can include known holiday periods, set opening hours, and minute delay setting for a specific time of day. These delay configurations can be used in calculating an earliest availability for a goods or service.

By way of example only, a client interface 230 enables authentication 232 of the client via a login and password, menu selection 234 from merchant provided menu items, ordering and payment 236 of goods or services.

Once the client has placed an order in the client interface, a print service module 240 prepare the print data for printing and transmits that data to a remote merchant premises 250 for printing by a remote printer 252. The print service can include an Microsoft active X competent for receiving XML print data and rendering this for the remote printer. The client interface further initiate a financial transaction with a finance gateway 260 for payment of the order. This payment can be made to a funds account associate with the remote order service provider, for subsequent payment to the merchant. Fees and/or commissions can be deducted from payments made to the merchant. It will be appreciated that payment can be made using any method, including any one or more of the following: a Credit Card, an Account and Cash.

As payment is made upon placing the order, the print service module 240 prepares a cancelation reference code that can be printed on the purchase order. Cancelation 265 of an order can be requested by the client though the client interface. To complete the cancellation (refund process) the client must obtain the cancellation code from the merchant. A client can then enter the cancelation reference code via the client interface to effect a funds refund.

A confirmation communication (for example, via email or SMS) can be sent to the customer. This confirmation communication can further include a tax invoice for payments made using a Credit Card or an Account.

By way of example, if sufficient time exists between the time a cancellation is requested and the selected pickup time, then the cancellation process can commence. A second cancellation ticket is delivered to the merchant. However, when the cancellation request is too close to the pickup time the customer can be prompted to phone the merchant to get the cancellation code. After the time of pickup, then the cancellation process must involve agreement from merchant via provision of the cancellation code.

A third-party server 270 can be operatively associated with the print service module 240 for communicating order print request data to a remote printer device 252. The third-party server device is preferably registered, and authenticated. The database preferably comprises data indicative of the third-party device registration and/or authentication. A fees and/or commission can be charged to a respective third party account for enabling access to the remote printer.

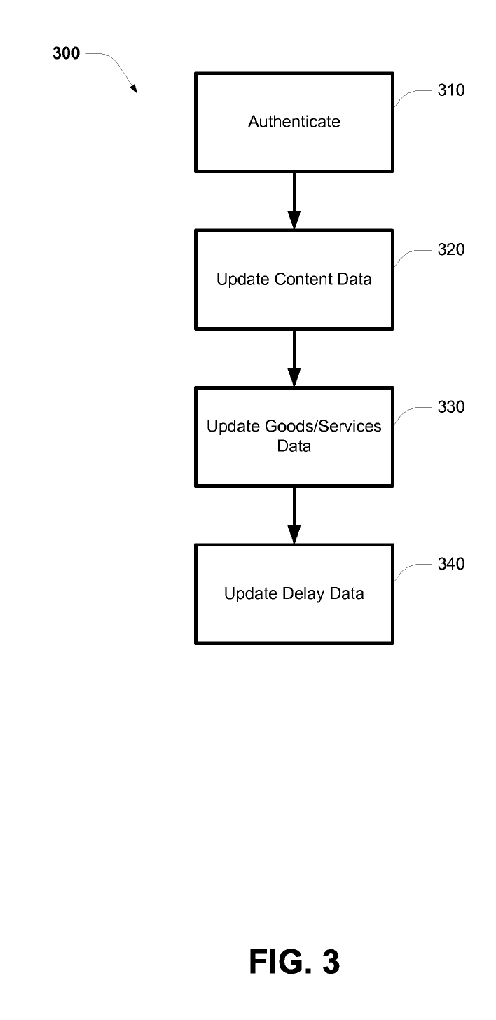

FIG. 3 shows a method 300 for a merchant accessing a merchant interface. The method includes the steps of:
STEP 310: Authentication by a merchant to access merchant data stored in the database;
STEP 320: Updating contact data indicative of goods or services offered by the merchant;
STEP 330: Updating goods and services data indicative of specific goods or services offered by the merchant;
STEP 340: Updating delay data indicative of specific delays known to the merchant.

Delay data can be updated manually or automatically. In an embodiment, delay data can be tracked on the basis of previous merchant response times. This delay information can be used in calculating an earliest availability for a goods or service. Delay information/data can, by way of example, can be calculated based on the time of day, specific items ordered and the total number of items. It can be beneficial to also identify those orders which are first time orders.

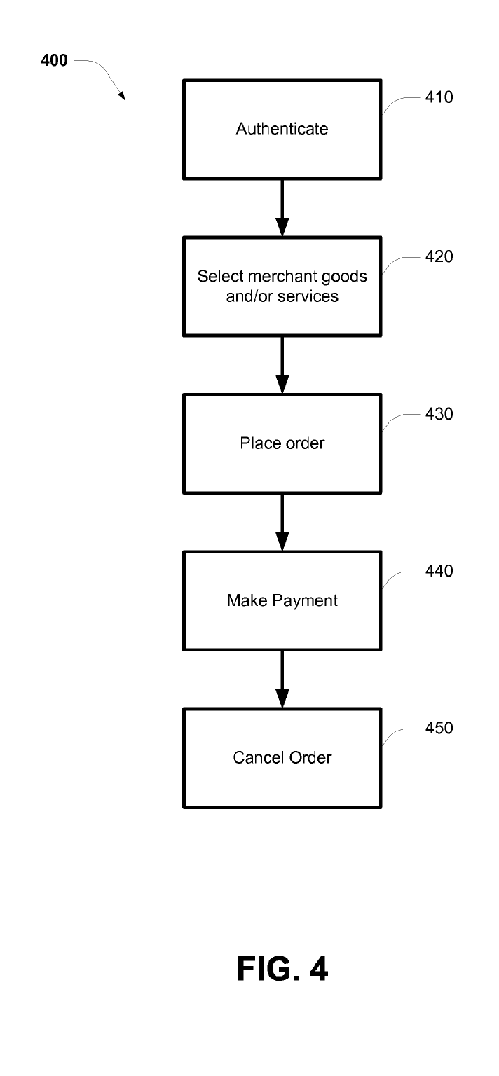

FIG. 4 shows a method 400 for a client placing a remote order via a client interface. The method includes the steps of:
STEP 410: Authentication by a client to access merchant data stored in the database;
STEP 420: Select specific merchant goods or services;
STEP 430: Place and order to the merchant, wherein the order is printed to a remote printer at the merchant premises;
STEP 440: Make payment for the goods or services ordered;
STEP 450: If the goods or services are not provide, or not provided in a merchantable quality, the client can cancel the order and obtain a refund.

The method further comprises the step of establishing an estimated order availability time. The earliest estimated order availability time is presented in a client interface using a calculated minimum delay based on merchant data and time of day.

The client interface can enables a client to be authenticated, select a merchant, select a pickup time for the order, place an order, and make a payment for the order. The client interface presents a minimum delay for the order to be available based on merchant data and time of day.

In an embodiment, the web server device is typically coupled to a financial server device for processing payment of a client order. The print request data includes a cancelation identifier for enabling a client to obtain refund.

By way of example only, making payment can include drawing down from a previously established account balance. Alternatively a credit or debit card can be used for making payment. A credit or debit card may be used in establishing an account balance that is draw down upon.

In an embodiment the remote printer device prints an order request. The order request includes a printed cancelation reference identifier. The client can input the cancelation reference identifier to the client interface to obtain a refund.

The database can further include client data indicative of a client. Client data can comprise any one or more of: contact details, past orders, status of current orders, and payment detail.

Merchant data is typically indicative of services or goods offered by a respective merchant. This merchant data can include any one or more of the following: contact details, payment details, goods or services data. Merchant goods or services data can further include any one or more of the following: menu details, and order delay details, operating hours, and minimum order delay for proceeding an order with respect to time of day.

The print service module monitors availability of the remote printer. A watchdog timer can be used in monitoring availability of the remote printer. The watchdog timer can be reset by receiving a response to a print request from the remote printer or by receiving a response to a handshake request. By way of example, a handshake request-response can include issuing a PING request and receiving a valid response.

The print server module can be adapted to establish a communication link to the remote printer over a wired network, or a combination of a wired data network and wireless data network.

It will be approached that a client access interface can comprise a control program, or computer program product, or computer program product having computer readable program means, or a computer readable medium for operation with a processor device adapted to perform the method of:
receiving data indicative of a client order;
preparing print request data;
communicating print request data to a remote printer.

Cafe Example

By way of example only, an embodiment remote ordering apparatus can include a 3GP enabled remote printing system (3GPrinter). This apparatus can be used as a Cafe/Restaurant meal ordering apparatus (MealOrder).

Remote ordering includes remote ordering of goods from a merchant. These goods ordered from a merchant include take-away comestibles that are prepared by the merchant upon receiving the client order.

In using this apparatus, a merchant can access services (typically for a fee or commission) that are intended to facilitate and enhance the current relationship with their customers. These services include:
A HTML CSS presentation of their menu, along with ordering and confirmation;
An API toolset, wherein an AJAX script sends and receives JSON packets of data that can be rendered onto the website page, such that a registered website can reference the toolset and display the API components;
Printing of dockets that contain the customers order;
Incorporation of opening hours, holidays and pickup delay schedule;
Additional customised web pages;
A cancellation system and dispute resolution process with the customer, monitored by exception with 3GP;
Providing an order history, logs of activity and financial statements; and
A full sub-domain for their presence.

The Customers are supplied with:
A method of order a meal from a range of merchants;
An account with 3GP, which can be draw down from when ordering a meal, and toped up when using the Payment Gateway with the Bank;
A cancellation method and/or dispute resolution process with the merchant, monitored by exception with 3GP.

A Merchant Interface is hosted on a SSL connection, and is accessed using a login and password authentication. This enables an individual merchant to configure aspects of their customer site or merchant data. In addition to this extranet (B2B) configuration the merchant interface further provides: login/password management, account management etc). These components allow the merchant to configure parameters of their dynamically hosted subdomain such that a merchant called “Cafe X” can have a client interface accessible via a subdomain “cafex. {Domain}.com.au

Generic Menu Standard and Data Model

A Generic Menu Standard (GMS) and Data Model enables a web server module to support multiple methods of menu construction. Cafe's and restaurants typically offer different types of food, and also present options arranged differently on a menu. The Generic Menu Standard is an interpretative method to encapsulate the different ways that a menu may be constructed. In this embodiment there are a plurality of data tables (in this example 5 data tables) that are constructed and related in a predetermined way to better enable a human operator to understand, interpret and modify the data. It will be appreciated that other data formats can be used in representing the Generic Menu Standard. In this menu standard the data can be represented as five sheets in a Microsoft excel spreadsheet. It would be appreciated the five tables can be represented in other forms, for example a spreadsheet file, database file or a plain text file formatted using comma-separated values (CSV).

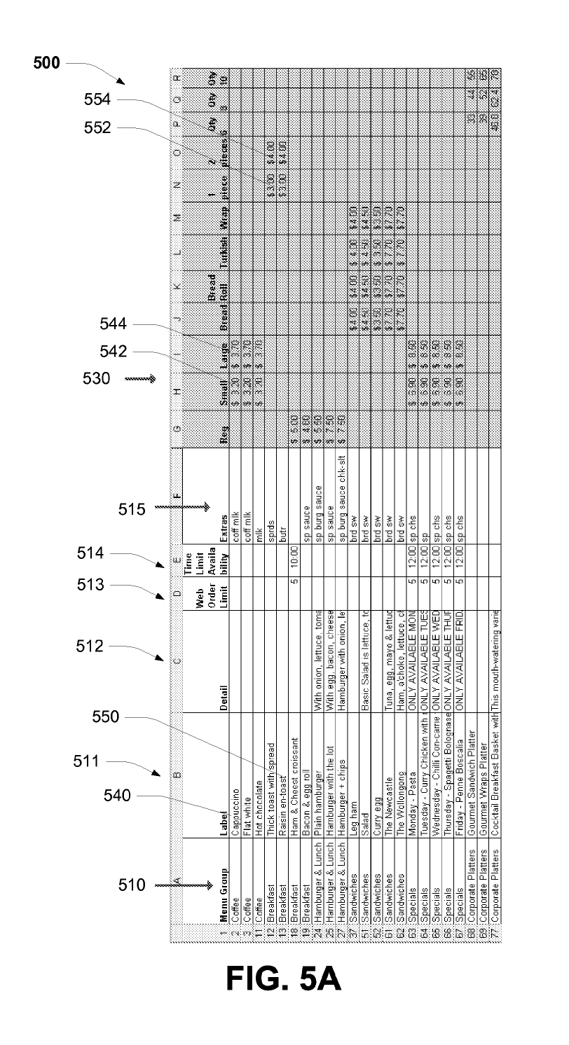

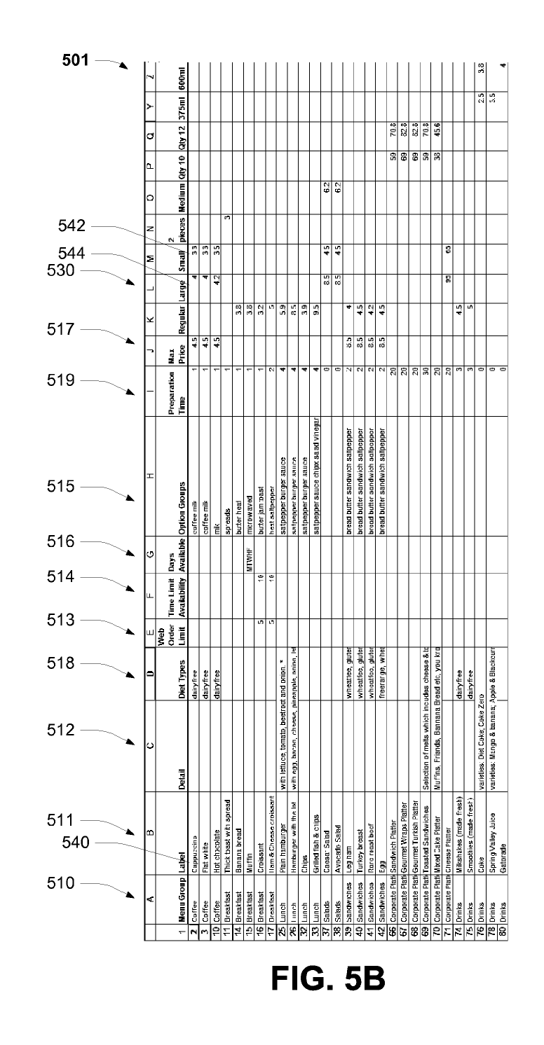

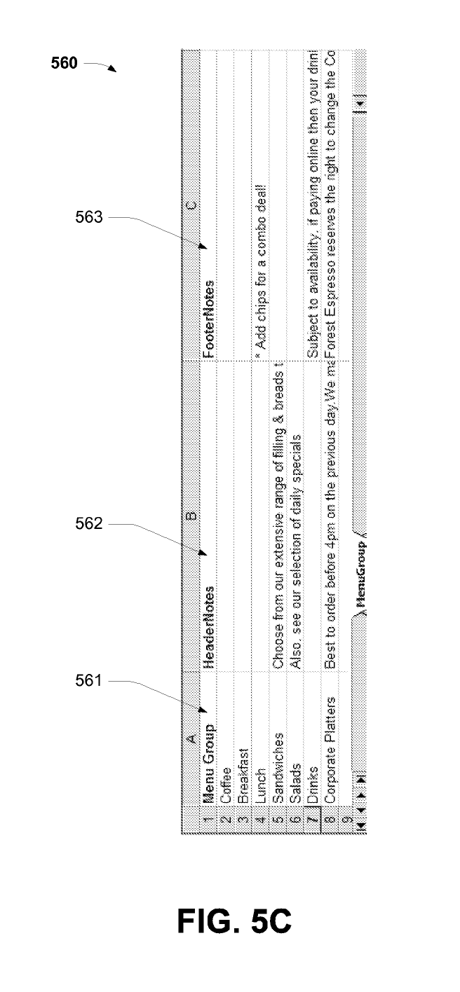

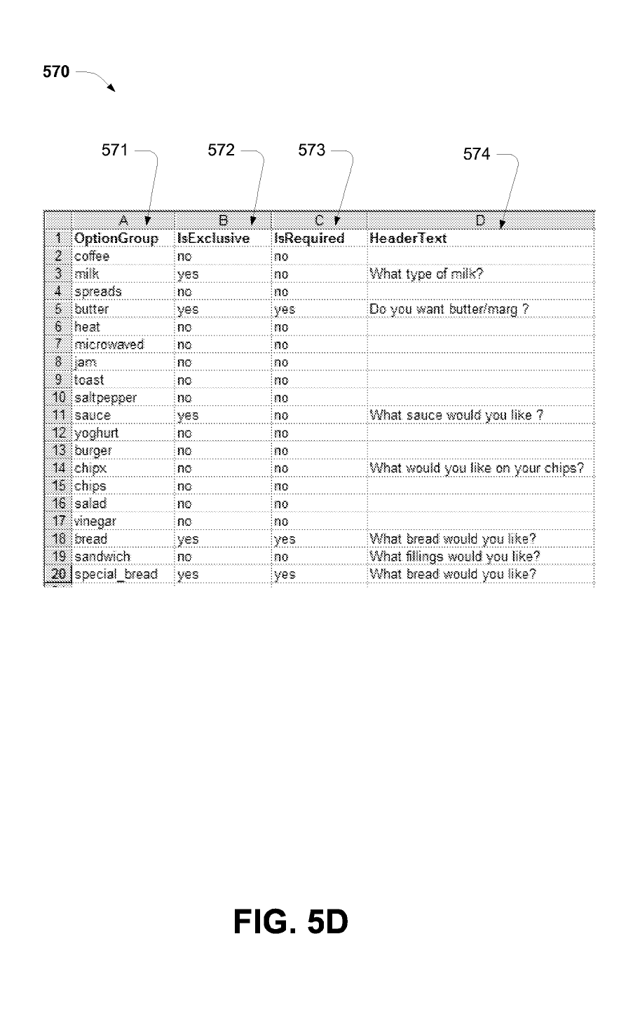

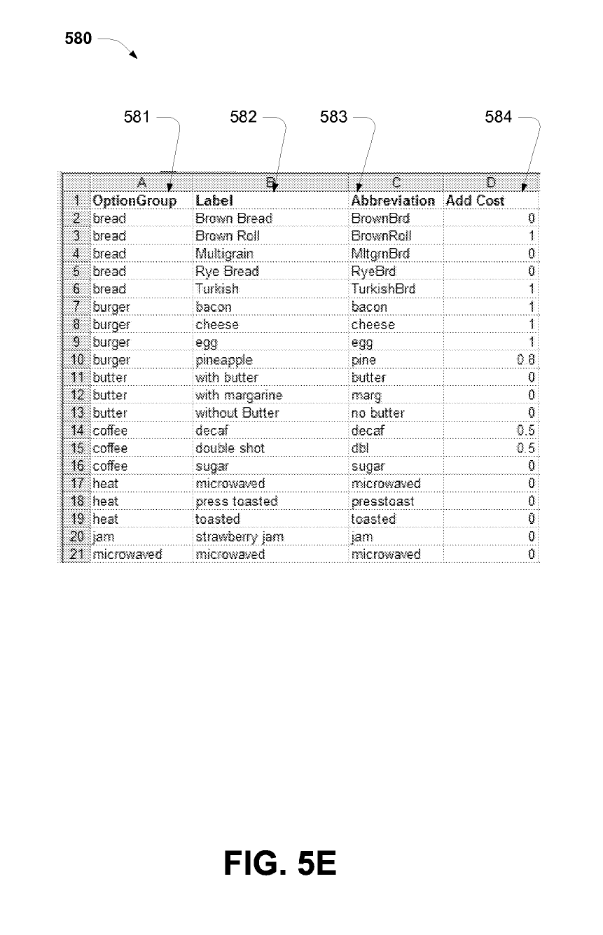

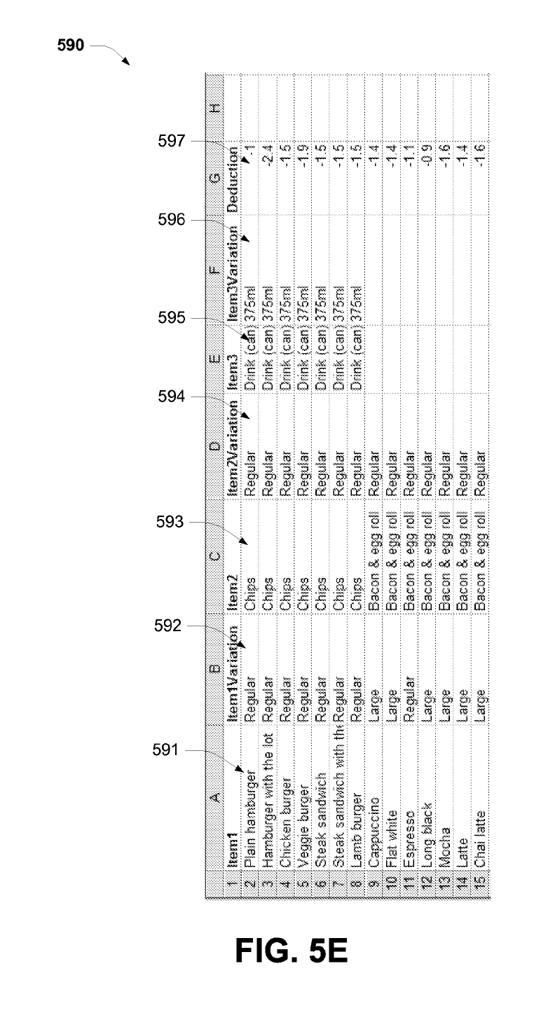

FIG. 5A though FIG. 5F show, by way of example only, tabular views of merchant data used in an embodiment remote ordering apparatus for representing menus data for a cafe.

Referring initially to FIG. 5A and FIG. 5B, example Generic Menu Standard (500,501) can be represented as a hierarch of three levels, being “Menu Group” 510, “Menu Items” 511 and “Variations” 530.

The “Menu Group” (510, 561) is the highest level, which is a plain text field that is indicative of the text used as part of a rendered http or web “navigation menu”, presented using the cafe website skin or client interface. There are also columns in this table 560 that include content for the header 562 and footer 563 of the Menu Group body of items when they are display on the web.

The “Menu Items” (typically a plain text descriptor) and their variations, each relate to a Menu Group (plain text), through which they can be grouped together. If spelling of the item referenced in the main group does not match with an item in the Menu Group table 560, then the menu item is considered to be an orphan and will not be displayed. Variations for each Menu Item are represented as columns within this table. The column label identifies the text used for the variation and the dollar and cents amount that corresponds to the Menu Item row, is the base price that the variation costs.

In the Menu Item Table (500,501), can include columns (fields) 1 through 8 comprising Menu Group 510, the Menu Item text 511, Detail 512, Diet Types, Web Order Limit 513, Time Limit Availability 514, Days Available 515, Option Groups Column (or Extras) 515, Preparation Time 516, and Max Price 517. Every column after this can define possible variations 530, such that as an example a Menu Item called “Cappuccino” 540 may belong to a “coffee” Menu Group and have a dollar/cents amount under the variation column called “Small” 542 and the variation column called “Large” 544, however a Menu Item called “Raisin Toast” 550 may have a dollar/cents amount under “1 piece” 552 and also under “2 pieces” 554, but will not have an entry under the “Small” or “Large” variation columns. It will be appreciated that this can enable column definitions to be used as variations which are fully customisable and extensible.

In an embodiment, a Diet Types field 518 for a menu item can contain a list of specific words that identify icons to display to the viewer when the are presented with the menuitem. Multiple diet types can be entered for any menu item in a list that is separated by a comma (CSV). Examples of diet types could be Vegetarian, Vegan, WheatFree, GlutenFree, DairyFree, FreeRange, Organic, FairTraide, LowGI, MildChilli, MediumChilli, HotChilli, but is not limited to this list. These classification are included as a means of adding marketing information for the viewer and in the full data model present a way to index specific menu items within and between menus.

WebOrderLimit 513, Time Limit Availability 514 and Days Available 516 fields can be used in calculating whether or not the item is available to be ordered. Web Order Limit is a per day limit which the cafe website interprets to mean that this is the number of items set aside for web orders and beyond which the item is “not available” if ordered via the website. If not available a message is returned to the user should they attempt to order this item once the limit has been reached. The TimeLimitAvailability is a time of day entry that informs the website to deliver a message should they order the item after this time of day, warning them that the item has limited stock and may not be available, or possibly a functional limitation to ordering the item. The DaysAvailable 516 field is an array of single text identifiers for the day of the week (M=Monday, T=Tuesday, W=Wednesday, H=Thursday, F=Friday, S=Saturday, U=Sunday), where if an entry appears in this field for a menu item, then the menu item can only be successfully ordered on the day specified.

In an embodiment, a preparation time column 519 can indicate an estimated number of minutes that it would take 1 person to prepare the item. This value is then used as part of a minutes delay system to help calculate the approximate minimum time to prepare an item. The minutes delay system is discussed below.

It will be appreciated that the ordering process can enable a user to build an order using the variation cost as the basic cost, and then subsequently added to through the incorporation of options and extras, then an upper ceiling of cost for an item can be declared in the Max Price column 517 such that any addition of options and extras will not take the total cost above the amount indicated in the Max Price column 517.

The 3rd level in the Generic Menu Standard defines the Extras 515 that could potentially be used for each menu item. This is reflected in the Menu Items table within the “Option Groups” column 515, and is defined as a space separated list (CSV) of Option Groups.

In an example embodiment, each option group corresponds has a corresponding entry in a spreadsheet called “Option Group” 570 having an option group elements identified in column 571. The option group can group together the various option items that appear in the another spreadsheet “Option Item” 580. The operation of each option group can be further defined in the Option Groups spreadsheet 570 through the fields IsExclusive 572 and IsRequired 573. The IsExclusive boolean field when set to “Yes” (or true) indicates that only 1 (one) option item from the option group can be selected and will display in HTML as a radio input field. When IsExclusive is set to “No” (false) then the HTML input field for each option item will be a checkbox such that multiple option items can be selected. The display of option items for each option group can be prefaced with a string of text identified in the HeaderText column 574 (eg: “What type of bread would you like?”). This header text can be any string of text that helps the viewer to understand the logically associated option items within the option group.

In an example embodiment Option Item spreadsheet 580 each row can indicates a specific option item and that is grouped together by the Option Group field 581, which textually matches an entry in the Option Group spreadsheet 570 in order to appear as an option item for that option group. In the Option Item spreadsheet 580, the Label column 582 indicates what text is displayed to the on screen viewing user, and the Abbreviation column 583 can indicates the text that would be printed out on the final docket were the option item to be selected by the on screen viewing user. The AddCost column 584 indicates additional cost added to the base menu item variation cost. Some option items have no additional cost and will be set to zero (eg: for the option group “bread” there might be an option item “white bread” with an additional cost of 0), whilst others may add cost to the overall item (eg: the option group “bread: there might be an option item labelled “Turkish Bread” which incurs and additional cost—for example $1). The “Add Cost” item therefore is a cost (dollar/cents) column associated with the extra table. It is possible for an option group to have many option items, and it is possible for an menu item to have many option groups, however through the addition of multiple option items to an order, the total price cannot exceed the Max Price set in field 517 of the menu item (as previously discussed) if a Max Price field is entered.

Referring to FIG. 5E, a fifth table in the Generic Menu Standard is referred to a Deductions 590 consists of Menu Items from the MenuItems table (500, 501) that when two or more of these items appear on an order trigger the associated amount to be deducted from the order total as a separate line item. By way of example only, when the menu item “Regular Hamburger” (591, 592) costing $5 is placed on and order, alongside the menu item “Regular hot chips” (593, 594) costing 2$ and the menu item “375 ml can of drink” (595, 596) costing $2 then—because these three items form a menu combination—a specified amount of $−1 (597) is deducted from a non discounted original total (i.e. $5+$2+$2−$1=$8).

The Generic Menu Standard is distinct in utilising a standardised database representation of the many millions of menus you might see in a cafe, and can offer a “standard” interpretation of a cafe or restaurant menu. Built into this standardisation approach is a degree of flexibility, where for example,
, a MenuItem called “sandwich platter” could have multiple variations called “platter for 6” and “platter for 10”; or alternatively
, two menu items can be respectively labelled “sandwich platter for 6” and “sandwich platter for 10” both having just one variation (the default labelling of which is just “regular”); or alternatively,
one menu item can be labelled “Sandwich platter” and include an option group called “PlatterQty” that has two option items called “Qty for 6” and “Qty for 10” where the quantity 6 option item has an additional cost of $0 and the quantity 10 option item has an additional cost equal to the price difference between a quantity 6 and a quantity 10 sandwich platter.

It will be appreciated that the above example embodiments can achieve a similar result of clearly identifying price difference between two items that are closely related, whilst allowing multiple methods for the display of the pricing information.

Minutes Delay Configuration System

A minimum amount of time for preparing an order can be determined (or estimated) by multiple factors being: the operating status of the vendor (Opening Hours and Holiday Schedule); the time of day the order is to be picked up/delivered which is intended to take into account the periodic business of the vendor; the individual preparation time of the items contained in the order, the total number of items on the order and the anticipated number of staff available to fill the order.

The delay calculation can typically considers all available factors, including any one or more of the following:
is the shop open (for example, holiday schedule and opening hours)?
is the shop busy (for example, time of day order delay table 600)?
how much time does it take to prepare the most complex item (i.e. maximum preparation time) which identifies the concurrency of order fulfilment (parallel component); and
does the number of items on order exceed the number of people available to fill that order (serial component).

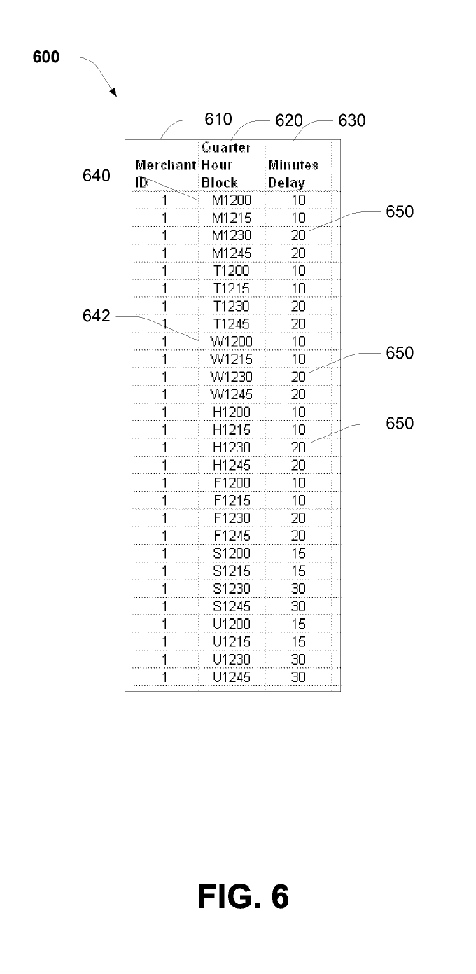

Referring to FIG. 6, a human interpretable differential delay table 600 enable a process to facilitate the calculation of a minimum pickup time from order placement. This table includes the columns indicative of a merchant ID 610, day of week and time specified in quarter hour blocks 620, and minutes of delay respective 630. Typically entries correspond to quarter hour blocks of a day, and enables a merchant to ‘program’ their site to a differential delay process. This can be further defined to distinguish different days, Monday ‘M’ 640 or Wednesday ‘W’ 642. The facilitates a merchant establishing different order delay time, for example, so that during peak times the merchant can better manage the expectations of the customer.

For example, the period between 12:30 pm and 1:00 pm 650 is typically the busiest time for a merchant selling predominantly to a lunch crowd, rather than have the customer think they can order and pickup within 5 minutes, the merchant can dictate that at these times the order will take a minimum of 20 minutes to get ready.

Minutes Delay Configuration can enable configuration for the following:
Opening Hours—day of week and start/end times
Holiday Schedule—days the café will be closed
Order Delay—blocks of time defined by start time that indicated the minimum number of minutes the order is estimated to be delayed.
Maximum Preparation Time for the menu items on the order, as defined by the menu item that has the highest PreparationTime value 519.
Total number of items on the order, such that the order delay is increased as more items are added to the order. The effect of total number of items will apply when the number of items is greater than the number of expected operating staff
Expected number of staff available to fill larger orders, which is default to 4, but may be set independently by the vendor.

The current date/time can be used as a reference point from which to calculate possible availability. For example, if the current date is a holiday, then the next valid opening time will be returned, this may be the next day, or it may be in several day's time. The Opening hours can determine the possible valid times that an order can be made available.

Once the first valid time has been determined the Order Delay table is referenced in order to find a corresponding record. If a corresponding record is found then the associated minutes delay will be added to the current time in order to calculate the minimum possible pickup time for the order. If no associated block is found in the table then a default time (typically 2 minutes) is applied to the first available time during opening hours.

By way of example, the entries in the Order Delay table 600 define the quarter hour blocks between 12 pm and 1 pm for all 7 days of the week. In this example the 5 character column called “Quarter Hour Block” defines the time of week, with the first character defining the day of the week, from the set of M,T,W,H,F,S,U.

Where the Holiday Schedule and Opening Hours define the open/closed state of the vendor, and the Time of day in the Order Delay Table 600 defines the minimum order delay for a given time of day, the Preparation Time for the menu items (for example, as defined in column 519) and the total number of items on the order contribution to the addition of more time to the minimum order delay in minutes.

In an embodiment, a maximum Preparation Time can be determined (or calculated) all the menu items on the order, from the MenuItems table (for example, tables 500 and 501) and this amount of minutes is added to the minimum order delay defined by the time of day.

In a further embodiment, when the number of items exceeds the default expected number of operational staff then an additional time component can be added for each additional item over the expected number of operation staff.

By way of example only, referring to table 600, if an order were to be placed for pickup at 12:05 pm (time of day delay is 10 minutes) on a day that the vendor is open, and the order contained six (6) items whose maximum Preparation Time for any single item was five (5) minutes and whose average Preparation Time for all items was one point three (1.3) minutes, and there were expected to be four (4) operational staff, then the calculation would be 10+5+((6−4)*1.3)=17.6, which means the minimum time that the customer could come and pickup their order would be 17 minutes and 36 seconds, which is rounded down to 17 minutes.

Simple Content Management System (S-CMS)

The merchant can upload a respective food menu using in the Generic Menu Standard defined above via a merchant interface. The Menu is typically prepared as an MS Excel spreadsheet. Once the menu is loaded into a data model, a menu can be constructed or rendered into a standard HTML output. This standardized HTML output can be further customised in appearance and function using a Cascading Style Sheets (CSS) (or ‘skin’). This can effect the rendering of both the represented menu and all associated merchant content. A merchant can select a specific look and feel on the basis of pre-prepared or customised style sheets, or they can supply their own specifically tailored CSS.

Additional content such as logos, banners, images, pages and text fragments can be loaded to enhance the look of the merchant specific pages. This additional content is typically constrained to read only (static) html type of content, substantially restricting “dynamic” content to the menu representation, the history of previous orders, the list of favourite items from previous orders, operating hours, holiday schedule and printer status.

Additional content can be specific to each merchant, such that it will appear to customers accessing the merchants menu pages. By way of example a merchant may add an additional page that promotes a community event that they are supporting, where the information is uploaded as a simple mark-up to be stored and presented as a separate page on their menu site.

Customer Ordering Portal

A customer or client is typically a person ordering food from a merchant via a client interface. Customers have an account with website service provider and it is through this centralised client interface that that they can authenticate (typically using an account name and password) and place an order. A web service domain ‘webDomain’ content provided for a typical cafe can consists of the following components.
About webDomain;
Contact webDomain;
Terms and Conditions/Privacy;
Join process pages;
Login process;
Account transaction history;
Account top up;
Payment gateway supporting pages (to and from the secure payment systems with the bank); and
Choose/Find a Merchant, with GPS supported pages.

Customers can have a default merchant in their profile. Once a Customer is authenticated a menu for their default merchant, which is part of the subdomain structure, is retrieved and rendered within a client interface. Alternatively, a client can have the merchants menu as a “favourite” or “bookmarked” link which will directly load a merchant menu. If a customer is not logged in, the customer can construct an order, but are prompted to log in (or join if they have not already done so) when the customer selects to place the order.

Customers can access menu and ordering details for any merchant on the system, however they can be presented with a shortened list of those merchants they have used in the past or which have been added manually to their shortlist. When retrieved a specific merchant menu, the interface shall be rendered using the skin (CSS) chosen or supplied by the merchant (as per the section Simple Content Management System above). From merchant to merchant, while using the same data model to represent each merchant menu, a menu rendered in a client interface can vary in content (content—what food is on offer) and look (design—look and feel). While a customer is registered with the centralised website remote ordering service provider, they can experience a specific and tailored client interface portal for each merchant food vendor.

Application Programming Interface (API)

An API can be provided that comprises a suite of tools written in Javascript and using established technologies such as JSON (Javascript Object Notation) and AJAX (Asynchronous Javascript and XML) to bring content from a server site and insert it into predefined areas on the merchants existing site.

In this configuration, the merchant can already have a registered domain name that is augment by adding tools that will allow the site to communicate with an external server technology. The merchant will include references to the Javascript libraries, and will ensure they have the appropriate HTML components in place within their existing HTML. These HTML components are typically “DIV” tags in the mark-up that have specific “ID” attributes which will be required for the API scripting to work properly. The script from the API libraries will send and received data (JSON packets) using calls (AJAX) and the take this data and arrange it within the predefined areas of HTML.

Whilst HTML, JSON and AJAX are all established technologies, the apparatus can API rendering and displaying content from a remote server site. This content will be menu specific information such as a list of menu groups, the list of menu items for a given group, or the various options associated with a menu item. The content can also include the list of favourite items for a customer, the opening hours, the holiday schedule, the order delay schedule, the deductions component of the menu as well as the printer status. The interpretation of all this information (or data) can be presented on a client browsers such that an order can be constructed before being sent to a final generic confirmation page hosted on the a server website. The server website can further provide access via a secure sockets layer (and through this any credit card information).

Websites Backend Component

Website backend component enables an order to be printed at the cafe on the wide area networked (wireless broadband) printer. The backend components utilise:
Print XML Standard
The Web Service
The Active X component.

Print XML Standard

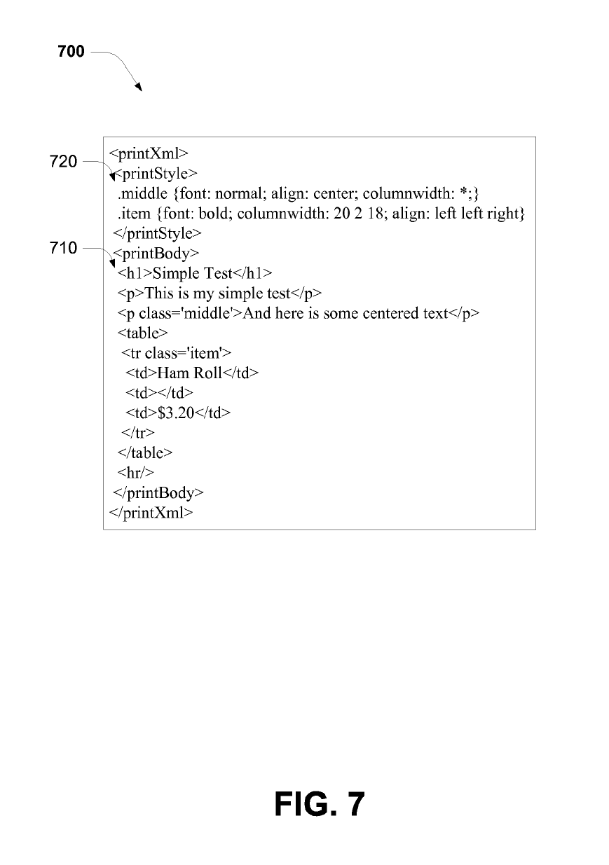

Referring to FIG. 7, a Print XML Standard can be represented in XML file 700 that is tailored to the requirements of the Cafe Printer System.

The Print XML is a mark-up language with very simple element and attribute structures.

By way of example only, tags in the PrintBody 710 can include:
hl double sized, double spaced font
p normal paragraph, normal space, normal sized (44 characters to a line)
table defines the beginning of a structure that has rows and columns
tr a table row that has a number of columns
td a table cell that has inherited font, alignment and column width properties
hr a horizontal line represented by 44 dash characters

The PrintStyle element 720 defines the classes that can be used in the PrintBody nodes individual tag elements. Example style attributes can be described as: font—having possible values normal, bold, doublewidth—interpreted having 22 characters per line;

columnwidth—having possible values {n} or *—interpreted as defining width in characters (44 max); and align—having possible values left, center

Web Service

A Web Service is an application programming interface, and part of the Service Orientated Architecture. It includes a generic set of resources that supply Print XML supported access to a printer for a given set of valid credentials.

A third party organisation can access the printer with the Web Service or “Service Orientated Architecture”. Consumers of the web service need to have a valid account with the service provider. Payment can be made on a per ticket method with a predetermined maximum number of characters on any one ticket.

The Web Service provides a specific set of tools for connecting to a remote printing device and in conjunction with the Print XML defined above, provides a way to output content on the printing device.

An Active X Component is a component object model (COM) defined process that runs as a service on a windows server. It is a print service interface through which the Web Service communicates to the start of a printer cue.

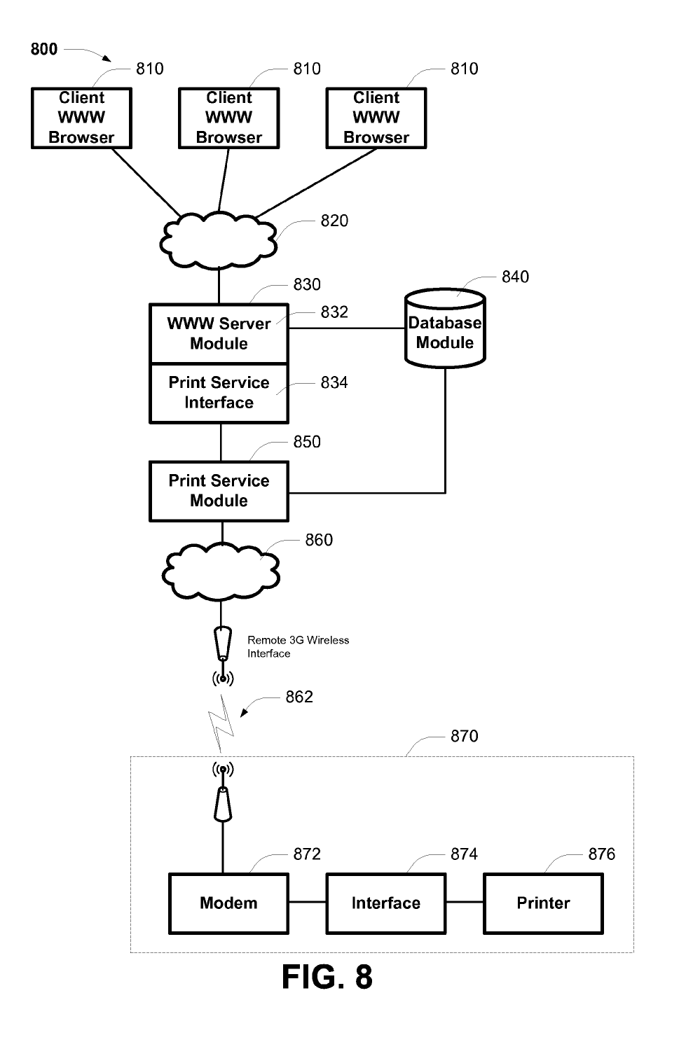

Referring to FIG. 8, Upon a client placing an order using a client interface 810, the web server 830 communicates with a remote site 870 to access a printer 876.

The data network 820 enables a Web Browser 810 that renders a client interface to communicate with a Web Server.

The data network 860 enables the Print Service 850 to communicate with a selected printer 876. A 3G mobile telephony network 862 can be used in communication.

A Web Server 830, having Web Server Application 832, provides access to a client interface and received data indicative of an order.

A Print Service Interface allows the web server application to communicate with the printers via a Print Service Module. By way of example, the service interface is a COM object that connects to the Print Service via a named pipe. The messages send on the named pipe include sending a print job to the printer, obtain the print job status and deleting of print jobs. The Print Service Module, along with the Print Service Interface, enable the Web Server to access a virtual Printer interface.

The Print Service Interface 834 is a COM object that tries to provide a virtual printer interface to a web server.

By way of example only, an exported print service interface can include the following:

tsgCafe.CafePrintJob

Create Print Job creates a new instance of tsgCafe.CafePrinter. The print job UUID is not created by CreatePrintJob and can be supplied by the caller. The reason for this is because the UUID should be coming from the database. Syntax for the VB6 Function CreatePrintJob(PrinterUuid as string, PrintJobUuid as string) As tsgCafe.CafePrinter, having parameters PrinterUuid [in] being a String containing the unique identifier of the printer and PrintJobUuid [in] being String containing the unique identifier of the print job. If this function succeeds the return value is tsgCafe.CafePrinter instance otherwise null.

Get Print Job Status return the state of the print job. Syntax for the VB6 Function GetPrintJobStatus(PrintJobUuid as String, Optional Timeout As Long) As Integer, having parameters PrintJobUuid [in] being a String containing the unique identifier of the print job, and Timeout [in, optional] being a Time to wait in milliseconds, default 10 s. Return Value. Get Print Job Status returns a single byte: 0 “UNKNOWN” defining Unknown or closed print job; 1 “QUEUED” defining Print job is waiting to be sent; 2 “PRINTED” defining Print job as been printed; 3 “NOTPRINTED” defining Print job processed but was not printed; 4 “INDETERMINATE” defining The print job as been sent but there as been no acknowledgement from the printer; and 255 “INTERNALERROR” defining Internal error. Close Print Job.

Close a print job. Syntax for the VB6 Function ClosePrintJob (PrintJobUuid as String, Optional Timeout As Long) As Integer having parameters PrintJobuUuid [in] bring a String containing the unique identifier of the print job, and Timeout [in, optional] Time to wait in milliseconds, default 10s. Return Value. Close Print Job returns a single byte as follows: 0 “UNKNOWN” defining Print job not found; 1 “DELETED” defining Print job closed; and 2 “NOTDELETED” defining Print job exists but not in a state that will allow closing.

tsgCafe.CafePrinter

Printer Begin Prepares a print job, and is the first function called. Syntax for the VB6 Subroutine is PrinterBegin ( ).

PageBegin resets the current font to single width, single height mode and appends three blank lines to the print job. Syntax for the VB6 Subroutine is PageBegin ( ).

PageFont allows setting the current font mode. Syntax for the VB 6 Property Let PageFont (rhs as Integer) Property Get PageFont as Integer, having parameters 1 “DOUBLELINE” defining Prints text in double height mode; 0 “SINGLELINE” defining Prints text in single height mode.; 2 “DOUBLEWIDTH” defining Prints text in double width mode; 0 “SINGLEWIDTH” defining Prints text in single width mode; and 4 “BOLD” defining Prints text in bold characters. The parameters for PageFont can be or'ed together.

Page Append. Syntax for the VB6 Subroutine PageAppend (text as string), having parameters Text [in] being a string to be append to the print job.

Page Append Line appends a string to the end of the print job data and then appends a carriage return and line feed characters. Syntax for the VB6 sub routine PageAppendLine (text as string), having parameters Text [in] begin a string to be append to the print job.

PageEnd completes the current page and appends a cut command to the print job. For starting a new page, PageBegin can be called. Syntax for the VB6 subroutine is PageEnd( )

PrintEnd completes the print job and sends the print job to the Service. An exception is raised if any printer commands are executed after calling PrintEnd. Syntax for the VB6 subroutine is PrintEnd ( ).

The Database Server 840 is provided for storing and retrieving data indicative of a client and/or a merchant. The Print Service can updates the database after completing print job. A reason for the service accessing the database can include the event driven nature of the Web Server and/or an Active Server Pages (ASP).

Each remote printer 876 can be uniquely identified, for example by a Universally Unique Identifier (UUID) or an International Mobile Equipment Identity (IMEI). The IMEI is typically padded with zeros to be the same length and format as an UUID. Any unique identifier of the printer can be referred as UUID.

The term Printer refers to a printer assembly. The printer assembly typically includes three components: 3G Modem 872, 3G Modem to physical Printer Interface 874 and a physical Printer 876.

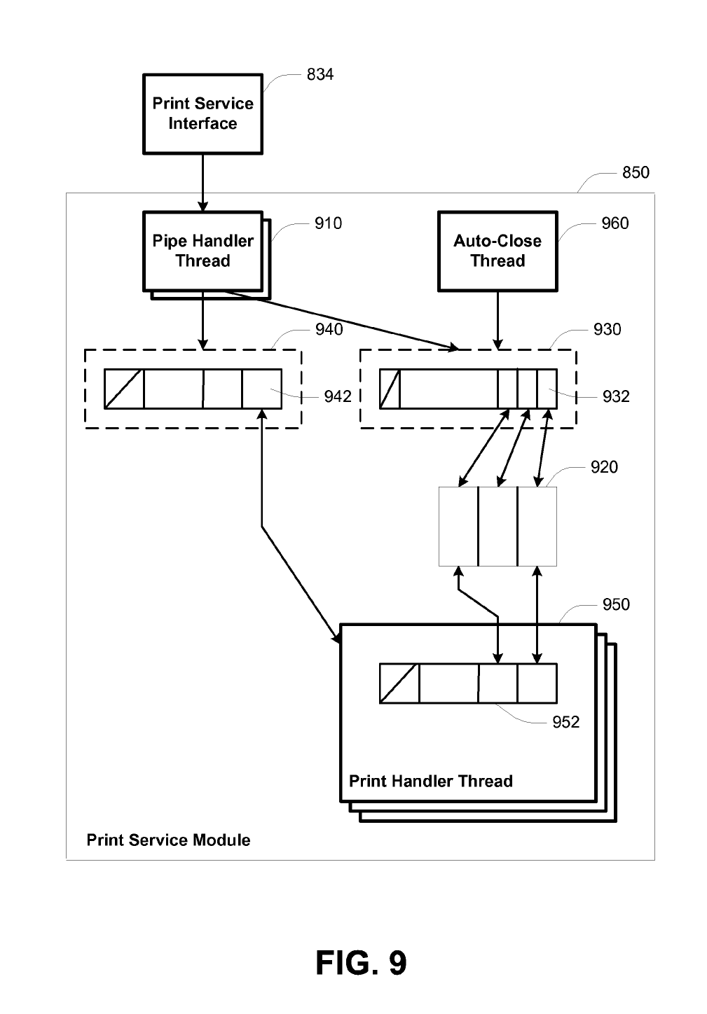

The 3G Modem to Printer Interface 874 can comprise a singled board computer or custom electronics. The term single board computer (SBC) will be used to refer to either a physical SBC or to the custom electronics. An operating system, for example Microsoft Windows XP, can be installed on the physical SBC and the application written as a Windows Service. On the custom electronic the application is written to duplicate the application on the SBC and is embedded into a microcontroller. In this example embodiment, Referring to FIG. 9 the Print Service Module 850 is a multithread Window service. The role of the service is to allow the Web Server to send print jobs to the printers in the field.

The Print Service Interface 834 sends a PRINT command to the Service Pipe handler 910. The pipe handler creates a new instance of that print job 920, sets its state to QUEUED and add to a print job list 920 a reference of the print job 922. Then the pipe handler performs a lookup in the print handler list 840 for an attached printer using the supplied printer UUID. If the printer UUID is not found then the pipe handler set the state of the print job to NOTPRINTED and returns NOTPRINTED to the Service Interface. If the printer UUID is found, then the pipe handler uses the reference to the attached printer to place a reference of the print job on the printer handler print job list then signals the printer handler thread 950 that there are waiting print jobs. Then the pipe handler returns QUEUED to the Service Interface. This command can be called by the Service Interface tsgCafe.CafePrinter PrintEnd function.

The Print Service Interface 834 sends a PRINTJOBSTATUS command to the Service Pipe handler 910. The pipe handler performs a lookup on the print job list 930 for the supplied print job UUID. If the print job does not exist then pipe handler returns UNKNOWN else it returns the current state of the print job. This command can be called by the Service Interface tsgCafe.CafePrinter GetPrintJobStatus function.

The Print Service Interface 834 sends a CLOSEPRINTJOB command to the Service Pipe handler 910. The pipe handler performs a lookup on the print job list 930 for the supplied print job UUID. If the print job does not exist then the pipe handler return UNKNOWN. If the print job exists and the print job has a state of PRINTED or NOTPRINTED then the pipe handler remove the print job reference from the print job list and deletes the print job instance. If the print job exists and not in the state of PRINTED or NOTPRINTED then the pipe handler does nothing This command can be called by the Service Interface tsgCafe.CafePrinter ClosePrintJob.

An Auto close thread 960 automatically close a print job that have been printed after five minutes.

One printer handler thread 950 is typically executing per printer connection.

The Web Service Interface/Print Service uses TCP/IP to establish a communication link with embedded print device. However, turning off the printer does not terminate a TCP/IP connection. A PING request message can be utilised in the printer handler thread. APING request message can be sent very 2 minute, and establish a 30 second time window for receiving a PING response message. If the printer does not reply within 30 second, the printer handler thread closes the TCP/IP connection and sets any outstanding print jobs to NOT_PRINTED. Sending a print job and receiving a reply can be treated the same as receiving a acknowledgment/response to a PING request message.

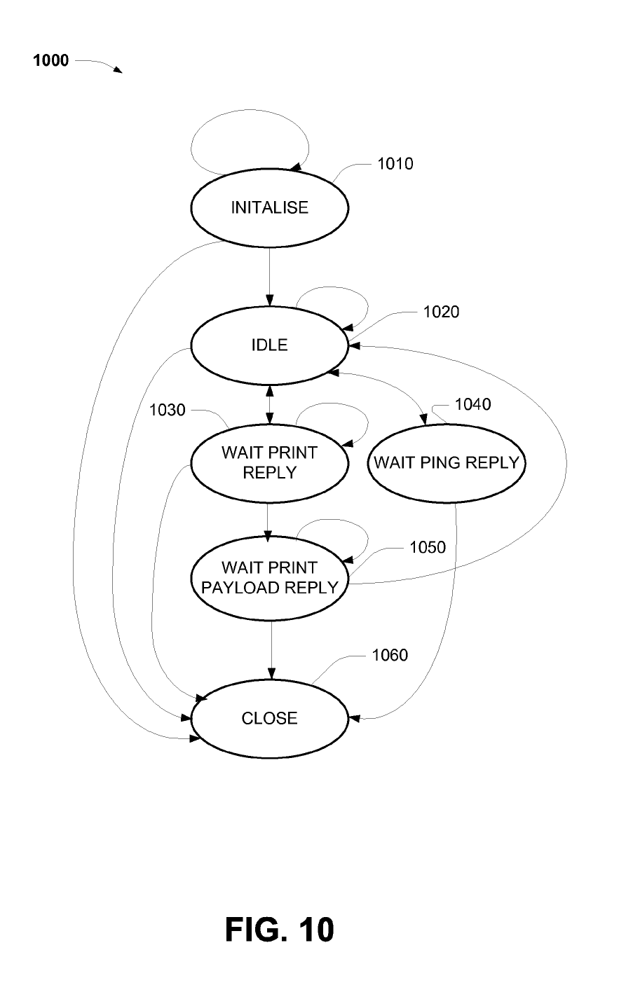

Referring to FIG. 10, a Printer Handler Finite State Machine can include:

```
INITIALISE: (STATE 1010)
    If received = “REGISTER” Then
        If printer already register then
            Signal other thread to deregister
        Register printer
        timer => 2min
        state => IDLE
    ElseIf timer expired
    Or connection lost Then
        state => CLOSE
    Else
        state => INITIALISE
IDLE: (STATE 1020)
    If print job ready Then
        transmit “PRINT”
        timer => 30s
        state => WAIT_PRINT_REPLY
    ElseIf timer expired Then
        transmit “PING”
        state => WAIT_PING_REPLY
    ElseIf connection lost
    Or deregister request Then
        Set all outstanding print jobs to NOT_PRINTED
        Deregister printer
        state = CLOSE
    Else
        state = IDLE
WAIT_PRINT_REPLY: (STATE 1030)
    If received = “NAK” Then
        Set print job state to NOT_PRINTED
        timer => 2min
        state => IDLE
    ElseIf received = “ACK” Then
        transmit print job payload
        transmit “.”
        timer => 30sec
        state => WAIT_PRINT_PAYLOAD_REPLY
    ElseIf timer expired
    Or connection lost
    Or deregister request Then
        Set print job state to NOT_PRINTED
        Set all outstanding print jobs to NOT_PRINTED
        Deregister printer
        state => CLOSE
    Else
        state => WAIT_PRINT_REPLY
WAIT_PRINT_PAYLOAD_REPLY: (STATE 1050)
    If received = “NAK” Then
        Set print job state to NOT_PRINTED
        timer => 2min
        state => IDLE
    ElseIf received = “ACK” Then
        Set print job state to PRINTED
        timer => 2min
        state => IDLE
    ElseIf timer expired
    Or connection lost
    Or deregister request Then
        Set print job state to INDETERMINATE
        Set all outstanding print job to NOT_PRINTED
        Deregister printer
        state => CLOSE
    Else
        state => WAIT_PEINT_PAYLOAD_REPLY
WAIT_PING_REPLY: (STATE 1040)
    If received = “ACK” Then
        timer => 2min
        state => IDLE
    ElseIf timer expired
    Or connection lost
    Or deregister request Then
        Set all outstanding print jobs to NOT_PRINTED
        Deregister printer
        state => CLOSE
    Else
        state => WAIT_PING_REPLY
```

Each remote printer can identified by either a Universally Unique Identifier (UUID) or an International Mobile Equipment Identity (IMEI.) The IMEI is padded with zeros to be the same length and format as an UUID.

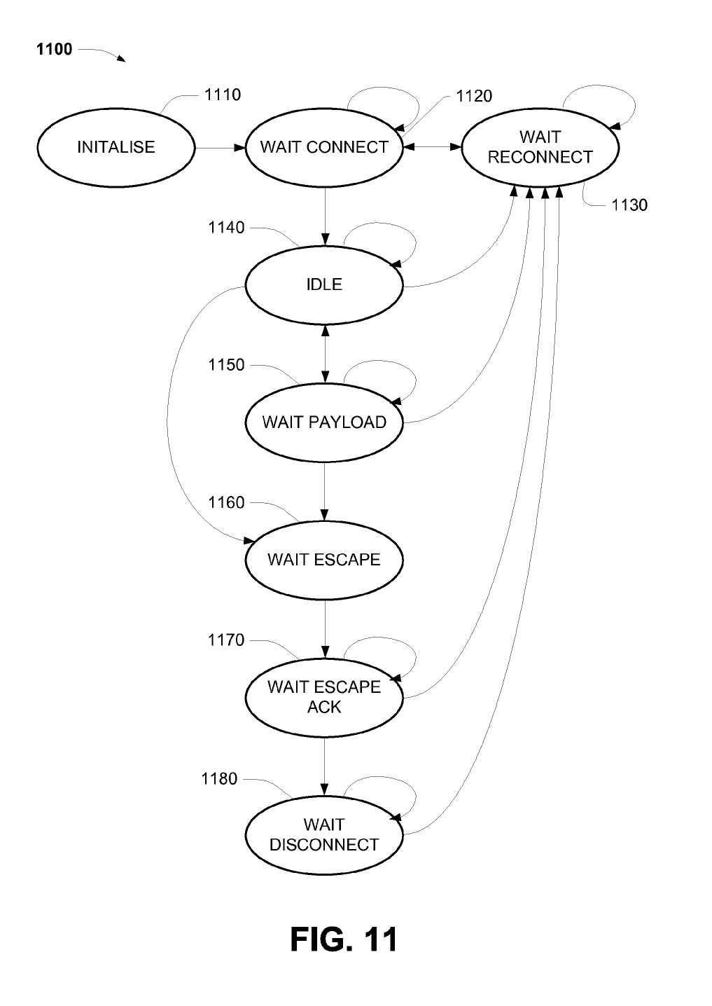

Referring to FIG. 11, a 3G Modem to physical Printer Interface (shown in FIG. 8 as 874) can implement a Printer Finite State Machine as follows.

```
INITIALISE: (STATE 1110)
    transmit to modem “AT!PADCONN=1”
    timer => 5min
    state => WAIT_CONNECT
WAIT_CONNECT: (STATE 1120)
    If received from modem = “CONNECT” Then
        transmit to modem “REGISTER” with UUID
        timer => 5min
        state => IDLE
    ElseIf received from modem = “NO CARRIER” Then
        timer => 10s
        state => WAIT_RECONNECT
    ElseIf received from modem = “ERROR” Then
        timer => 30s
        state => WAIT_RECONNECT
    ElseIf timer expired Then
        Reset modem
        timer => 10s
        state => WAIT_RECONNECT
    Else
        state => WAIT_CONNECT
IDLE: (STATE 1140)
    If received from modem = “PRINT” Then
        If printer online Then
            Transmit to modem “ACK”
            timer => 30s
            state => WAIT_PAYLOAD
        Else
            Transmit to modem “NAK”
            timer => 5min
            state => IDLE
    ElseIf received from modem = “PING” Then
        Transmit to modem “ACK”
        timer => 5min
    ElseIf received from modem = “NO CARRIER” Then
        timer => 10s
        state => WAIT_RECONNECT
    ElseIf timer expired Then
        timer => 2s
        state => WAIT_ESCAPE
    Else
        State => IDLE
WAIT_PAYLOAD: (STATE 1150)
    If received from modem any string Then
        Transmit to printer the string
        timer = 30s
        state = WAIT_PAYLOAD
    ElseIf received from modem = “.” Then
        Transmit to modem “ACK”
        timer => 5min
        state => IDLE
    ElseIf received from modem = “NO CARRIER” Then
        Transmit to printer “VOID”
        timer = 10s
        state = WAIT_RECONNECT
    ElseIf timer expired then
        Transmit to printer “VOID”
        Transmit to modem “NAK”
        timer => 2s
        state => WAIT_ESCAPE
    Else
        state => WAIT_PAYLOAD
WAIT_ESCAPE: (STATE 1160)
    Transmit to modem “+++”
    timer => 30s
    state => WAIT_ESCAPE_ACK
WAIT_ESCAPE_ACK: (STATE 1170)
    If received from modem = “OK” Then
        Transmit to modem “AT!PADDISCONN”
        timer => 30s
        state => WAIT_DISCONNECT
    ElseIf timer expired Then
        Reset modem
        timer => 10s
        state => WAIT_RECONNECT
    Else
        state => WAIT_ESCAPE_ACK
WAIT_DISCONNECT: (STATE 1180)
    If received from modem = “OK”
    Or “ERROR”
    Or “NO CARRIER” Then
        timer => 10s
        state => WAIT_RECONNECT
    ElseIf timer expired Then
        Reset modem
        timer = 10s
        state => WAIT_RECONNECT
    Else
        state => WAIT_DISCONNECT
WAIT_RECONNECT: (STATE 1130)
    If timer expired Then
        Transmit to modem “AT!PADCONN=1”
        timer => 5min
    Else
        state => WAIT_RECONNECT;
```

Real Time Physical Printer Status can be provided by a printer application continuously polling the physical printer for status. This polling only occurs when the printer application is not in the WAIT_PAYLOAD status. The printer goes offline when it is not powered, cover open or out of paper.

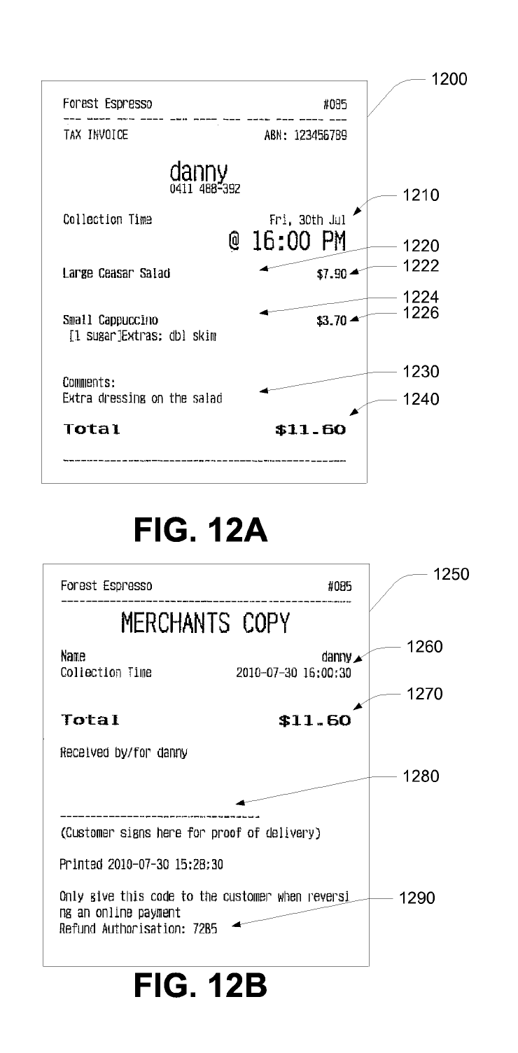

Referring to FIG. 12A, an embodiment order request 1200 can be printed at a merchant remote site. The order request 1200 includes the selected pickup time 1210, the order—comprising the item(s) ordered 1220 and 1224 and their respective costs 1222 and 1226—customer provided comments 1230 and a total cost 1240. This order request can further be used to provide a tax invoice for the customer.

Referring to FIG. 12B, an embodiment ‘merchant copy’ order request 1250 can also be printed at a merchant remote site. This order request 1250 includes the selected pickup time 1260, a total cost 1270, a section for the customer to acknowledge receipt 1280, and a refund authorisation code 1290.

It will be appreciated that the illustrated apparatus and methods facilitate remote ordering.

Interpretation

The following abbreviations are used herein:

| | |
|---|---|
| COM | Component Object Model |
| TCP/IP | Transmission control protocol/Internet protocol |
| UUID | Universally unique identifier |
| IMEI | International Mobile Equipment Identity |
| SBC | Single Board Computer |
| ASP | Active Server Pages |
| FSM | Finite State Machine |
| 3G | International Mobile Telecommunications-2000 (IMT-2000) |

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. A remote ordering apparatus, the apparatus being coupled to a digital data network to enable communication to a client device for presenting a client interface, the ordering apparatus comprising:
a database comprising merchant data;
a web server device coupled to the data network and adapted to interrogate the database;
wherein the web server device comprises a server module for providing a client interface configured to receive a client order; the server device further comprises a print service module; the print service module being operatively associated with the server module for enabling communication of an order print request data to a remote printer device over a data network.

2. (canceled)

3. An apparatus according to claim 1, wherein the client interface enables a client to be authenticated, select a merchant, and place an order.

4. An apparatus according to claim 3, wherein the client interface enables a client to select a pickup time for the order.

5. An apparatus according to claim 3, wherein the client interface presents a minimum delay for the order to be available based on merchant data and time of day.

6. An apparatus according to claim 3, wherein client interface enables a client to make a payment for the order.

7. An apparatus according to claim 1, wherein the web server device is coupled to a financial server device for processing payment of a client order.

8. An apparatus according to claim 1, wherein the print request data includes a cancellation identifier for enabling a client to obtain a refund, and a refund can be provided to the client.

9. An apparatus according to claim 1, wherein the remote printer device prints an order request.

10. An apparatus according to claim 9, wherein the order request includes a cancellation reference identifier.

11. An apparatus according to claim 10, wherein the client can input the cancellation reference identifier to the client interface to obtain a refund.

12. An apparatus according to claim 3, wherein the database includes client data comprising any one or more of: contact details, past orders, status of current orders, and payment detail.

13. An apparatus according to claim 3, wherein the merchant data can include any one or more of the following: contact details, payment details, menu details, order delay details, operating hours, minimum order delay and holiday schedule.

14. (canceled)

15. An apparatus according to claim 9, wherein the remote printer is monitored by a print service module monitors to identify availability.

16. An apparatus according to claim 15, wherein the print server module establishes a communication link to the remote printer over a data network.

17. An apparatus according to claim 9, wherein a third-party server device is coupled to the digital data network and is operatively associated with the print service module for communicating order print request data to a remote printer device.

18.-25. (canceled)
